(19) United States
(12) Patent Application Publication
(10) Pub. No.: US 2023/0100374 A1
(43) Pub. Date: Mar. 30, 2023

(54) Temperature conditioned food ingredient dispenser for robotic or automated cooking apparatus

(71) Applicant: Kitchen Robotics Ltd, Modiin (IL)

(72) Inventors: David BEN-DAVID, Rehovot (IL); Yair GORDIN, Modiin (IL)

(21) Appl. No.: 17/448,898

(22) Filed: Sep. 27, 2021

(51) Int. Cl. A47J 47/01; G05B 19/042; B65G 33/10

(52) U.S. Cl. CPC A47J 47/01; G05B 19/042; B65G 33/10; G05B 2219/2643; B25J 11/0045

(57) ABSTRACT

The invention relates to a temperature conditioned, refrigerated or heated, food ingredient dispenser for automated or robotic apparatus. And more particularly it relates to using plurality of dispensers, stacked in an array, for minimizing space occupied and wherein the components of the ingredient dispenser are removable and replaceable.

### FIELD OF THE INVENTION

The present application relates to an automated or robotic apparatus. And more particularly it relates to using plurality of dispensers, stacked in an array, for minimizing space occupied and wherein the components of the ingredient dispenser are removable and replaceable, while being conditioned, refrigerated or heated.

### BACKGROUND OF THE INVENTION

Dispensing of food ingredients is a key factor in automated food preparation processes. Performance and efficiency of food preparation automated systems is highly dependent on factors such as food ingredient dispensing speed, accuracy, ingredient refill duration and cleaning and maintenance duration. Moreover, the food ingredients must comply with the food safety regulations and kept refrigerated.

In an automatic or robotic food preparation system, incorporating moving parts, motors and wiring, the food ingredient dispenser, the feeder's, refrigeration to work in sync becomes a complex task. Moreover, refrigerated chamber or enclosure's energy efficiency is compromised with frequent ingredient refills.

Another crucial factor in robotic and automated systems is footprint. Bulky refrigeration chambers require bigger footprint and access area.

Various innovations in food dispensing techniques for food preparation have been identified.

U.S. Pat. No. 4,738,114A titled, “Temperature-controlled food dispenser” talks of a portable temperature-controlled food dispenser for dispensing condiments, salad dressings and related types of foods under temperature control to prevent or at least retard food spoilage by preferably suitably cooling such foods. A thermally-conductive receptacle on the dispenser receives and supports selected alternative arrangements of thermally-conductive magazines for dispensing individual portion packs of food and thermally-conductive bulk storage food dispensing containers. The receptacle enables heat transfer between the receptacle and the selected arrangement of magazines and food containers on the receptacle. An electrically-powered heat exchanger is thermally coupled with the receptacle to enable heat transfer between the heat exchanger and the receptacle. A power supply circuit is connected with the heat exchanger to enable electric power to be supplied to the heat exchanger to effect the heat transfer between the heat exchanger and the receptacle to control the temperature of the selected arrangement of magazines and food dispensing containers on the receptacle.

U.S. Pat. No. 3,312,33A titled, “Refrigerated food dispenser having a reciprocating ejector” relates to a dispenser for refrigerated foods and it relates more particularly to a device for dispensing separated pats of butter and for maintaining a supply of such pats of butter in a refrigerated state for dispensing.

WO2010098851A2 titled, “System and method of temperature adjustment and control of food processing/dispensing system or apparatus” is directed to improvements to the temperature control systems and methods used within a food processing and dispensing device. Specifically, the present invention measures, by a thermocouple assembly, the actual temperature of food product ingredients and transmits one or more signals to a CPU. The signals represent the actual temperature of the one or more food product ingredients measured by the first thermocouple assembly. Then the CPU employs one or more look-up tables within the CPU to determine a set point temperature of a food processing surface. The system and/or method measures the actual temperature of the food processing surface, using a second thermocouple assembly, and transmits one or more signals to the CPU representing the actual temperature of the food processing surface. The temperature of the food processing surface is then dynamically adjusted to the determined set point to offset the temperature of the food product ingredients.

Besides, DE602004018413D1 titled, “Temperature-controlled dispensing device for dispensing free-flowing food” also is an invention that has some relevance to the above-stated refrigerated dispensing in food preparation process.

However, in none of these inventions, the dispensers and their mechanisms are not adoptable to an automatic or robotic environment, as is the central focus of the proposed invention. The following description describes a dispensing process especially in a temperature controlled environment and operable in an automatic or robotic food preparation process in a synced manner.

### SUMMARY OF THE INVENTION

An aspect of the invention is to provide a temperature conditioned, refrigerated or heated, food ingredient dispenser for automated or robotic apparatus, such as but not limited to automated kitchens, vending machines, robotic food preparation system, dosing systems, food handling and storage systems.

A further aspect of the invention is to provide a dispenser which might be horizontally or vertically oriented, stand alone or integrated in a robotic apparatus.

Another aspect of the invention is to provide a dispenser which might be suitable for raw, half cooked or fully cooked, sliced or whole, such as but not limited to pasta, tomatoes, olives, cut or sliced onions, lattice, kale, nuts, meat, chicken, fish etc.

A still further aspect of the invention is to provide a dispenser where the food ingredients might be dispensed by a rotational movement, rotating elements such as augers or flaps which might be generated by an electrical motor or pneumatic actuator or drive mechanism.

A further aspect of the invention is using plurality of dispensers, stacked in an array, for minimizing space occupied.

Another aspect of the invention is removable dispenser. All dispenser components having direct or indirect contact with food, requiring sanitation and maintenance, can be removed manually or automatically for cleaning and sanitation.

Yet another aspect of the invention is removing or replacing one of more parts or components of the dispenser during continuous operation of a robotic or automated system and the temperature conditioning system.

A still further aspect of the invention is the dispenser structure and geometry, creating an air channel for conditioning the dispenser, excluding the rotational motor, rotating the auger. This is facilitated by creating a concealed air channel when stacked side by side.

A further aspect of the invention is directing preconditioned air through the air channel which might be refrigerated or heated.

Another aspect of the invention is providing the dispenser with surface roughness, which might be N7 or N6 or N5 or N4 or N3 or N2 or N1, according to ISO grade surface roughness numbers.

Another aspect of the invention is keeping positive air pressure level inside the air channel for ensuring that the air reaches all dispenser surfaces, being conditioned.

Yet another aspect of the invention is dispenser construction material which is chosen depending upon the faster and efficient dissipation of heat from the surface of the dispensers.

A further aspect of the present invention is mixing the food ingredients for even temperature distribution.

### REFERENCE NUMERALS

100 Ingredient dispenser

110 Food ingredient Cartridge

120 Dispenser main body

130 Auger

140 Electric motor

150 Retainer Socket

160 Cavity of dispenser main body

170(a) & 170(b) Vertical feeder side walk

### BRIEF DESCRIPTION OF THE DRAWINGS

FIG. 1 represents a front elevational view of an array of dispensers arranged horizontally of the present invention.

FIG. 2 represents a 3-dimensional view of an array of dispensers arranged horizontally of the present invention.

FIG. 3 represents the direction of the conditioned air flow and the creation of air channels between any two consecutive dispensers positioned horizontally in an array of the present invention.

FIG. 4 represents an enlarged view of a single dispenser and the flow of conditioned air of the present invention.

FIG. 5 represents the various components of the ingredient dispenser of the present invention.

FIG. 6 is the elevational view of the ingredient dispenser with the electrical motor attached with the augur in the present invention.

FIG. 7 represents the elevational view of a single ingredient dispenser with the removable augur, electrical motor and the augur release mechanism in an engaged position.

FIG. 8 represents the elevational view of a single ingredient dispenser with the removable augur, electrical motor and the augur release mechanism in a disengaged position.

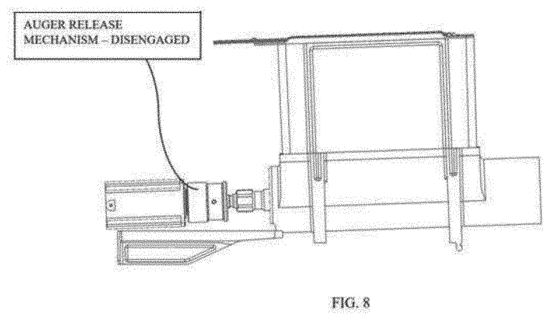

FIG. 9 represents an enlarged view of the augur release spring loaded retention socket of the present invention.

FIG. 10 represents another enlarged view of the the augur release spring loaded retention socket of the present invention.

FIG. 11 represents the removable components of the ingredient dispenser of the present invention in a disengaged position.

FIG. 12 represents the interface between the ingredient main body and the ingredient cartridge.

### DETAILED DESCRIPTION OF THE INVENTION

The following description of the embodiments of the invention is not intended to limit the invention to these embodiments but rather to enable a person skilled in the art to make and use this invention.

The food ingredient dispenser (100) of the present invention comprises of three components:

A food ingredient cartridge (110), a dispenser main body (120) and an auger (130). The ingredient cartridge functions as a temporary vessel to hold ingredients until the appropriate time in the cooking process and facilitates adding the cooking apparatus. The food ingredient cartridge (110) can be removably coupled to the dispenser main body (120) wherein the food ingredient cartridge unit (110) can be temporarily attached at least during a cooking process.

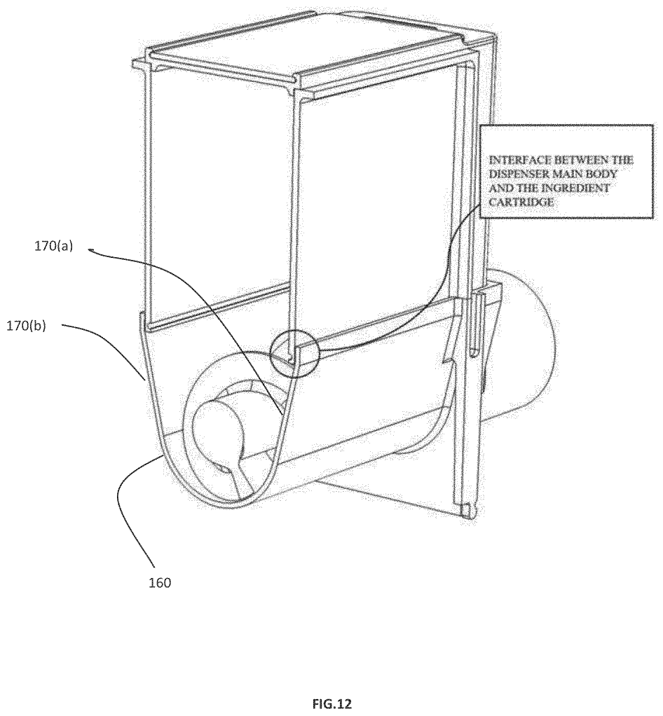

The food ingredient cartridge is inserted on top of the dispenser main body (120) as depicted in FIG. 12. The nominal width and the nominal length of the ingredient cartridge might be 0.1 mm or 0.2 mm or 0.5 mm or 1 mm or 2 mm smaller than the relevant interface dimension of the dispenser main body (120), in order to achieve an intermediate fit. Intermediate fit of the interface between the dispenser main body (120) and the food ingredient cartridge (110) enables manual removal and replacement.

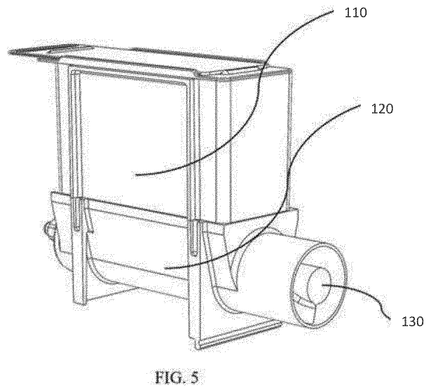

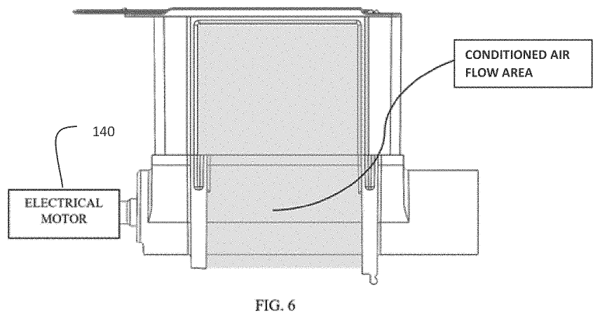

The food ingredients might be dispensed by the rotational movement of the rotating elements including augers or flaps (130) as depicted in FIG. 5. The rotational movement might be generated by an electrical motor (140) or pneumatic actuator or drive mechanism as shown in FIG. 6.

The food ingredient dispenser (100) of the present invention might be suitable for raw, half cooked or fully cooked, sliced or whole, such as but not limited to pasta, tomatoes, olives, cut or sliced onions, lattice, kale, nuts, meat, chicken, fish etc.

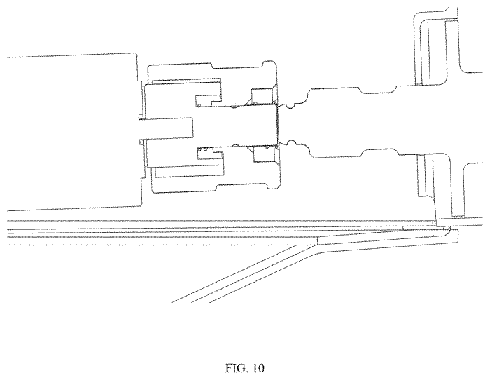

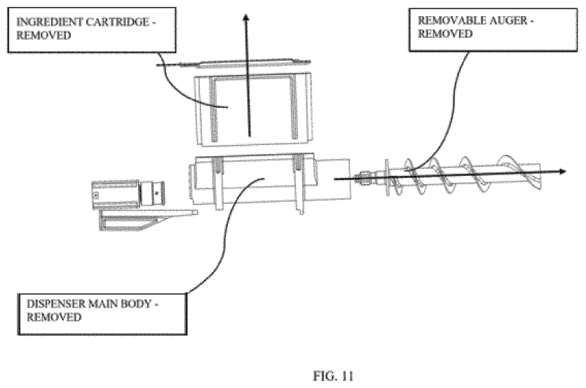

The auger (130) is fitted into the dispenser main body (120), containing an opening fitting the outer diameter of the auger (130). The auger (130) comprises of an interface for the engage mechanism, assembled on the electrical motor (140). For example, when the auger (130) is inserted into the dispenser main body (120) to its operational position, the engage mechanism is locked, thus constraining the dispenser main body (120) in place. When the retainer socket (150) of the engage mechanism as depicted in FIG. 10, is pulled back, manually or automatically, the auger (130) is released, the rotational force is no longer transmitted and the dispenser main body can be removed as depicted in FIG. 11.

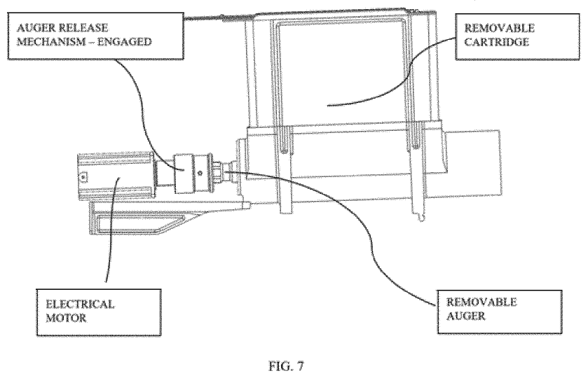

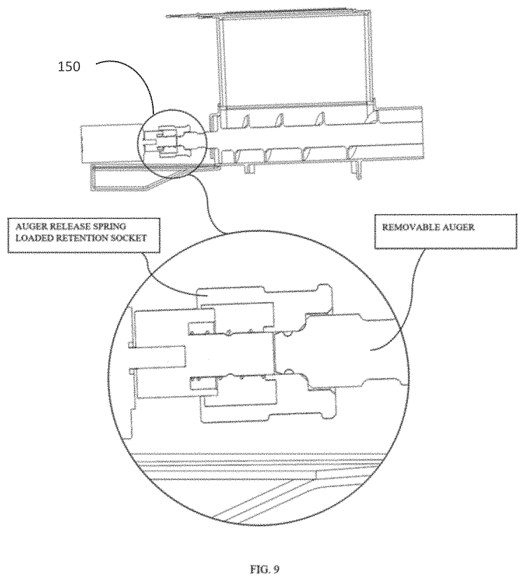

An aspect of the invention is providing a food ingredient dispenser (100), wherein, each of the components can be independently removed for cleaning and sanitation and again reassembled during operation as depicted in FIG. 11. An example may be removing or replacing the rotating auger (130). The dispenser (100), when assembled or mounted on a robotic or automated cooking system, being fully operational, is locked in place by constraining the auger (130) to the electrical motor (140) rotating it as depicted in FIG. 7. The auger (130) is constrained by a release mechanism, manually or automatically engaged, or disengaged, thus locking and unlocking the dispenser auger (130). Manually operated release mechanism, for example, as described in FIG. 9, transfers the rotational movement from the electrical motor (140) to the auger (130), thus rotating it and comprises of a retainer socket (150), which can be manually engaged and disengaged as depicted in FIG. 10, locking and unlocking the auger (130) and the dispenser (120) in place. The engage and disengage is a result of a linear motion of the retainer socket (150) which might be spring loaded, as described in FIG. 9, for default engage position. The interface between the retainer socket (150) and the auger (130) might be of hex cross section, or rectangular cross section or triangular cross section, in order to transmit the rotational force from the electrical motor (140), for example, to the auger (130). The rotational motion can be transmitted by incorporating elements such as keyway, pin or any other protruding element fitting into the retainer socket accordingly.

In embodiments of the present invention, the food ingredient dispenser may be temperature conditioned, refrigerated or heated, for automated or robotic apparatus, such as but not limited to automated kitchens, vending machines, robotic food preparation system, dosing systems, food handling and storage systems.

In some embodiments, the one or more components or parts of the dispenser can be removed or replaced during continuous operation of a robotic or automated system and the temperature conditioning system. For example, a food ingredient cartridge may be removed to refill a specific ingredient and then replaced again. Another example might be removing the complete dispenser for cleaning and maintenance.

In some embodiments of the present invention, the food ingredient dispenser (100) might be horizontally or vertically oriented, stand alone or integrated in a robotic apparatus.

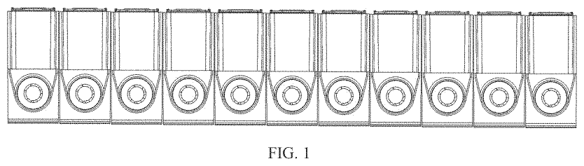

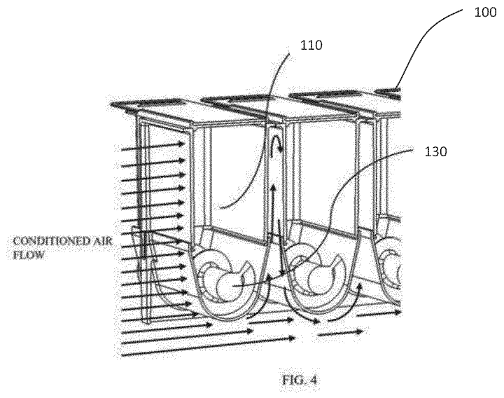

In further embodiments of the present invention, a plurality of dispensers, stacked in an array, as described in [FIG. 1] may be used, thus minimizing space occupied. The present invention, enables stacking multiple dispensers in a row, where, each one of them is separately accessible, removable and replaceable, thus creating an array of dispensers augmented by the shape and geometry of the dispenser and its components as shown in [FIG. 4].

In aspects of the invention, one or more components can be removed, or all components can be removed. As depicted in FIG. 11, all dispenser components, having direct or indirect contact with food, requiring sanitation and maintenance, can be removed manually or automatically for cleaning and sanitation.

In some embodiments a single dispenser may be removed from an array of dispensers or plurality of dispensers, during continuous operation of a robotic or automated system and the temperature conditioning system.

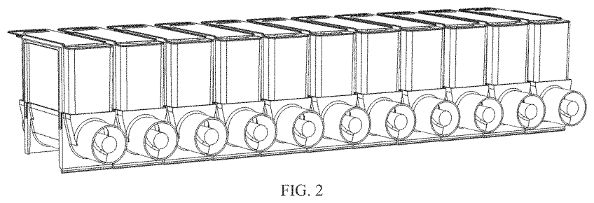

The ingredient dispenser main body (120) forms a cavity (160) like “U”, wherein, the cavity is defined to position the auger (130) and the two vertical feeder side walls of the “U” (170a) and (170b) interfaces with the removable ingredient cartridge (110) as depicted in FIGS. 1 to 5 and 12.

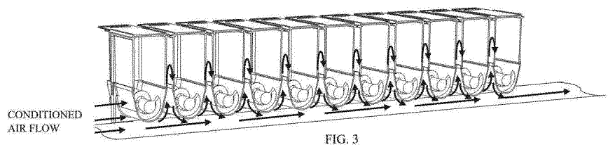

Referring further to FIG. 3, the surface geometry of the dispenser body (120), creates a concealed air channel when stacked side by side. Wherein, 2 or 3 or 5 or 10 or 20 or 30 dispensers can be stacked side by side creating the air channel. The preconditioned air which may be heated or refrigerated may be directed through the air channel.

The air flow might be conditioned by a refrigeration unit or a heating unit or an air conditioning unit, integrated in the robotic system or a stand-alone unit or a central conditioning unit. Temperature difference between the dispenser's surface, exposed to the air flow, and the air flow, generates a heat transfer by convection.

The heat transfer depends on the conditioned air flow characteristics, such as air velocity, temperature difference between the air flow and the dispenser surface and the roughness of the dispenser surface, being conditioned, as expressed by Newton's law of forced convection:

$$\text{?} = hA ( \text{?} - \text{?} ) ( W ) \\ \text{?} \text{indicates text missing or illegible when filed}$$

As described above, one of the factors determining the transfer of heat of the air flow depends upon roughness of the dispenser surface which is manufactured according to ISO grade surface roughness numbers and may be N7 or N6 or N5 or N4 or N3 or N2 or N1. The surface roughness effect, among others, on the convective heat transfer coefficient h, addressed in the Newton law of convection, is described in the above section. Smooth surface increases the convection heat transfer, improving the temperature conditioning. The surface roughness of the conditioned surfaces of the dispensers can be achieved by manufacturing technologies such as plastic injection molding, machining and polishing, EDM.

Another factor determining the transfer of heat of the air flow is keeping positive air pressure level inside the air channel to ensure that the air reaches all dispenser surfaces, being conditioned. The pressure might be obtained by air blower, compressor, fan and the air pressure values might be 100 Pa, 300 Pa, 500 Pa, 1000 Pa, 2000 Pa.

Referring again to FIG. 5, for even temperature distribution, mixing of the food ingredients is another aspect of the present invention. The auger (130), dispensing the ingredients, can rotate in both directions, the dispensing direction and a direction opposite to the dispensing direction. Rotating the auger (130) in direction opposite to the dispensing direction generates movement of the food ingredient inside the dispenser body and cartridge, resulting in mixture of the ingredient. Mixture of the ingredient results in alternate contact of the food ingredient with the refrigerated surface thereby resulting in even refrigeration.

An aspect of the invention, is the construction material to be used for the dispenser. As is known in the art, that higher thermal conductivity results in higher heat flux, therefore the dispenser construction material used should have high thermal conductivity for efficient food ingredient conditioning. The heat is conducted between the air stream and the food ingredient, represented by the equation:

q=−k∇T

Where k is the material thermal conductivity and q is the heat flux density.

For example, aluminum dissipates heat about 15 times faster than stainless steel, having a higher thermal conductivity coefficient. Thus, dispenser made of aluminum, rather than stainless steel will dissipate heat faster and more efficiently.

The present disclosed subject matter may be a system, a method, and/or a computer program product. The computer program product may include a computer readable storage medium (or media) having computer readable program instructions thereon for causing a processor to carry out aspects of the present disclosed subject matter. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pukes passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages, The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter. Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description, but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. Temperature conditioned food ingredient dispenser for robotic or automated cooking apparatus comprising:
a dispenser main body;
a removable food ingredient cartridge; and
an augur,
wherein, the surface geometry of the said dispenser main body forms a “U” shaped cavity, which is defined to accommodate the said augur and wherein, the two vertical feeder side walls of the “U” interfaces with the said removable food ingredient cartridge; and
wherein,
the said removable food ingredient cartridge, configured to be fitted on top of the dispenser main body, is nominally smaller than the interface dimension of the said dispenser main body for achieving an intermediate fit; and
wherein the rotational movement of the augurs dispenses the food ingredients from the ingredient cartridge,
characterized in that, the surface geometry of the said dispenser main body, allows stacking multiple dispensers in a row thereby, creating an array of dispensers.

2. The ingredient dispenser of claim 1, wherein the surface geometry of the dispenser main body, creates a concealed air channel when stacked in a row, through which preconditioned air is directed through it.

3. The temperature conditioned food ingredient dispenser of claim 1, wherein, the number of dispensers which can be stacked side by side for creating an air channel varies between 2 to 30.

4. The temperature conditioned food ingredient dispenser of claim 1, wherein the width and length of the ingredient cartridge is smaller than the interface dimension of the dispenser main body for achieving an intermediate fit enabling manual removal and replacement of the food ingredient cartridge.

5. The temperature conditioned food ingredient dispenser of claim 1, wherein the difference in width and length of the ingredient cartridge from the dispenser main body is nominal and varies between 0.1 mm and 2 mm.

6. The ingredient dispenser of claim 1, wherein the preconditioned air is heated by a heating unit integrated in the robotic system or a stand-alone unit or a central conditioning unit.

7. The ingredient dispenser of claim 1, wherein the preconditioned air is refrigerated by a refrigeration unit integrated in the robotic system or a stand-alone unit or a central conditioning unit.

8. The temperature conditioned food ingredient dispenser of claim 1, wherein one or more components or parts of the dispenser is removable and replaceable during continuous operation of a robotic or automated system and the temperature conditioning system.

9. The temperature conditioned food ingredient dispenser of claim 1, wherein the said food ingredient dispenser is horizontally oriented.

10. The temperature conditioned food ingredient dispenser of claim 1, wherein the said food ingredient dispenser is vertically oriented.

11. The temperature conditioned food ingredient dispenser of claim 1, wherein the said food ingredient dispenser is stand alone.

12. The temperature conditioned food ingredient dispenser of claim 1, wherein the said food ingredient dispenser is integrated in a robotic apparatus.

13. The temperature conditioned food ingredient dispenser of claim 1, wherein, the temperature conditioning of the ingredient dispenser is improved by the degree of smoothness of the surface of the ingredient dispenser and is manufactured by injection molding, machining and polishing.

14. The temperature conditioned food ingredient dispenser of claim 1, wherein, for mixing of the ingredients and for even temperature distribution in the ingredients the said auger, dispensing the ingredients, can rotate in both directions, the dispensing direction and a direction opposite to the dispensing direction.

15. The temperature conditioned food ingredient dispenser of claim 1, wherein, the material used for the ingredient dispenser is aluminum.
